(19) United States
(12) Patent Application Publication
(10) Pub. No.: US 2005/0130638 A1
(43) Pub. Date: Jun. 16, 2005

(54) System and method for simplified conference initiation

(76) Inventor: Thies Schrader, Haslum (NO)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/983,973

(22) Filed: Nov. 8, 2004

(30) Foreign Application Priority Data
Dec. 12, 2003 (NO) 2003.5562

(51) Int. Cl. H04M 3/42

(52) U.S. Cl. 455/416; 455/414.1

(57) ABSTRACT

The present invention discloses a method and a system for initiating, routing and scheduling conferences. A dial URL is introduced with a prefix unique for calling purposes. When a user activates such a URL in a web browser, a content handler associated with the browser recognizes the type of URL and sends a request to a managing tool to determine an available calling route between the user's preferred end-point and the end-point being addressed in the URL with the required resources. The managing tool then schedules the resources and initiates the call between the end-points. The invention allows for a one-click initiation of ad-hoc calls and conferences.

### RELATED APPLICATION

This application claims priority under 35 U.S.C. § 119 or 365 to Norwegian Application No. 20035562, filed Dec. 12, 2003. The entire teachings of the above application are incorporated herein by reference.

### BACKGROUND OF THE INVENTION

Conventional conferencing systems comprise a number of end-points communicating real-time video, audio and/or data streams over and between various networks such as WAN, LAN and circuit switched networks.

A number of conference systems residing at different sites may participate in the same conference, most often, through one or more MCU's (Multipoint Control Unit) performing i.a. switching functions to allow the audiovisual terminals to intercommunicate properly.

As videoconferencing involves various resources and equipment simultaneously interoperating at different locations and capabilities, there is a need for the possibility to manage the resources involved both for scheduled and ad hoc videoconferences. The wording schedule or scheduler shall also be understood as including setting up ad-hoc meetings or calls—insuring that all required resources are available for the call.

Conferencing systems are therefore often provided with a management tool. The management tool may i.a. include a resource scheduler. The resource scheduler is a module that is used to schedule or book resources at any given point in time. The resource scheduler will allow a user to request resource usage at a given time, and either allow or disallow the usage at that time. Resource schedulers are often used for scheduling the use of meeting rooms, network resources, video systems etc. The resource scheduler must be connected to a database containing updated information regarding all accessible resources like MCU's, gateways, routers, end-points etc.

A resource scheduler may e.g. provide system and resource overview, allowing the user to create, edit, and delete reservations, reserve resources for dial-in participants and specify bandwidth and network settings. The resource scheduler may also support automatic call routing—automatic selecting use of a point-to-point connection, or including one or more MCU's. The resource scheduler normally operates with an intuitive web interface requiring no additional installation on the user terminal other than a conventional web browser.

The patent application NO 2003 2859 discloses a presence/Instant Messaging system connected to scheduling and accomplishment of a conference. Presence and IM applications are known as applications indicating whether someone or something is present or not. A so-called “buddy list” on a user terminal shows the presence of the people or systems (buddies) that have been added to the list. The list indicates if the “buddy” is present or not (logged on the computer, working, available, idle, or another status). The presence functionality creates a feeling of presence also with people or objects that are located in other buildings, towns, or countries.

By connecting a presence application to the resource scheduler, a first user will be able to see when a second user is present (not busy with something else), and at the same time, an idle conferencing system may be selected according to the priority list of the second user. This will provide a new ad-hoc possibility to common resources, as unnecessary calls (due to ignorance of presence information) will be avoided and manual negotiations through alternative communication prior to the call will not be required. A double click on a “buddy” in a “buddy list” may e.g. execute an immediate initiation of a call to the “buddy” using the most preferred idle system associated with the “buddy”.

However, in NO 2003 2859, a call can only be made to users already defined in the “buddy-list”. The invention also assumes that a presence/IM application is installed in the user terminal.

Another problem is that it may be hard to locate and find people, and even if a person is located, required information for initiating a call(e.g. dial out prefix, gateway to use—or if required at all—MCU used as gateway, etc.) may still be missing.

Still another problem is that direct ad hoc dialing in prior art requires that the same protocol is being used on both originating and terminating side. As an example, SIP URLs are used for ad hoc calls between SIP-end-points, but this is not possible for calls between SIP and H.323 end-points or SIP and H.320 end-points. A call between end-points operating at different protocols requires one or more intermediate Gateways whose resources have to be booked, and no solutions providing resource scheduling in connection with one-click dialing is known in prior art.

### SUMMARY OF THE INVENTION

The present invention is directed to a method and system that avoids the above described problems.

The features defined in the independent claims enclosed characterize this method and system.

In particular, the present invention discloses a method for routing and establishing a call or a conference from an originating user to one or more terminating users each associated with one or more respective end-points, whereby when a URL (Universal Resource Locator) with a unique dial prefix is activated, requesting a management tool to determine an available route of resources between a preferred one of the one or more end-points associated with the originating user and a respective preferred one of the one or more end-points respectively associated with the one or more terminating users, determining, by means of a routing module included in said management tool, a number of routes between said preferred one of the one or more end-points associated with the originating user and said respective preferred one of the one or more end-points respectively associated with the one or more terminating users based on capability and connection data stored in a database for the respective end-points and said resources, and assigning a cost value to each of said number of routes representing delay, bandwidth and/or reliability, determining, by means of a scheduling module included in said management tool, which of said number of routes whose resources currently and/or in near future are being idle, based on status data of said resources stored in said database, and selecting a route among which, having the lowest cost value, as said available route, and establishing the call or conference from said preferred one of the one or more end-points associated with the originating user to said respective preferred one of the one or more end-points respectively associated with the one or more terminating users through said determined available route.

The invention also discloses a corresponding system performing the above-described method.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram showing the different elements involved in an example embodiment of the present invention.

FIG. 2 is a flow sheet illustrating the steps of a method according to one aspect of the present invention.

### DETAILED DESCRIPTION OF THE INVENTION

A description of preferred embodiments of the invention follows.

In the following, the present invention will be discussed by describing a preferred embodiment, and supported by the accompanying drawings. However, people skilled in the art will realize other applications and modifications within the scope of the invention as defined in the enclosed independent claims.

The present invention suggests using special type URLs in a conventional web browser to initiate an ad hoc conference call from a user terminal. URLs (Universal Resource Locators) are being used for identifying resources in a network (typically the internet). URLs exist for among others ftp (file transfer protocol) and http (hypertext transfer protocol) locations. As an example, when clicking on http://www.tandberg.net/, the web browser will request the site with the address www.tandberg.net to download the content of which to the web browser's terminal using the HTTP protocol, and the content will after downloading show up on the screen. Conventionally, when clicking on a link in a web browser, a content handler is requested to analyze the URL to determine the characteristics of the link, and initiate further actions according to the content. Thus, it is also allowable with URLs that do not go directly to locations, but initialize a certain service or application on the local system. Such URLs include prefixes indicating the service to be used. Examples are mailto-links that start creating an e-mail message to a specific person. A mailto-link is in html-code typically represented by the anchor tag <a> with a hyperlink attribute (href) that includes the prefix “mailto”, followed by a colon and a mail-address, e.g. <a href-“mailto:name@domain”>text</a>. When clicking at a mailto-link, the phrase “mailto” executes start-up of a default mail application associated with the web-browser for handing the mailto-link (if the mail application is not already running), and creates a new empty e-mail with the given mail-address inserted in the address field of the e-mail. In this way, the user does not have to bother about the mail-address of the receiver of the e-mail, or what kind of e-mail application the web-browser or terminal is using.

According to the present invention, a special conference prefix is used in the URL to initiate an ad-hoc conference call from a web browser. In addition to indicating the link type, the prefix should preferably also include information of what kind of conference call to be initiated. Examples of call links include:
dial-h323:0012121212012(gatekeeper
dial-h320:+1 (555) 1231234
dial-sip:user@company.com

Referring to the first link, “Dial” indicates that a dialing service is about to be initiated, “h323” indicates that the subsequent address is an H.323 address, and “0012121212012@gatekeeper” is the address of the end-point to be called, associated with the given gatekeeper. If the user or the web browser's terminal (e.g. a PC, PDA or mobile phone) has predefined a preferred conferencing end-point, a click on a dial-link will define one originating and one terminating end-point. In case of having predefined more than one preferred end-point, the most preferred currently idle end-point will be selected as the originating end-point.

The minimum available information that is required to initiate a call or conference between two end-points is unique identification of the terminating system to be called. However, in connection with conferencing, identification of end-points are not always sufficient to set up a call, and in some cases, i.a. due to IP limitations and firewall/NAT obstacles, a unique identification is neither possible. Intermediate resources like Gateways, MCUs, which bandwidth to use, end-point capabilities etc. have to be considered in order to provide a stable connection with an adequate quality, or even to be able to establish a connection at all. Conventionally, this may be provided manually through a user interface of the management tool. An administrator then has to determine in advance the required resources for a scheduled call or conference, based on his knowledge of the participating end-points and of the available resources. However, in the case of ad hoc conferences, the routing and scheduling of resources has to be carried out automatically.

According to the present invention, the content handler therefore also sends a request to a management tool for providing automatic routing and resource scheduling for the call between the parties when identifying a dial-prefix in an activated URL. The routing and resource scheduling could also be carried through by other applications like stand-alone modules e.g. accessible through a presence/IM application installed on the user terminal, but for simplicity, the term management tool will be used in the following.

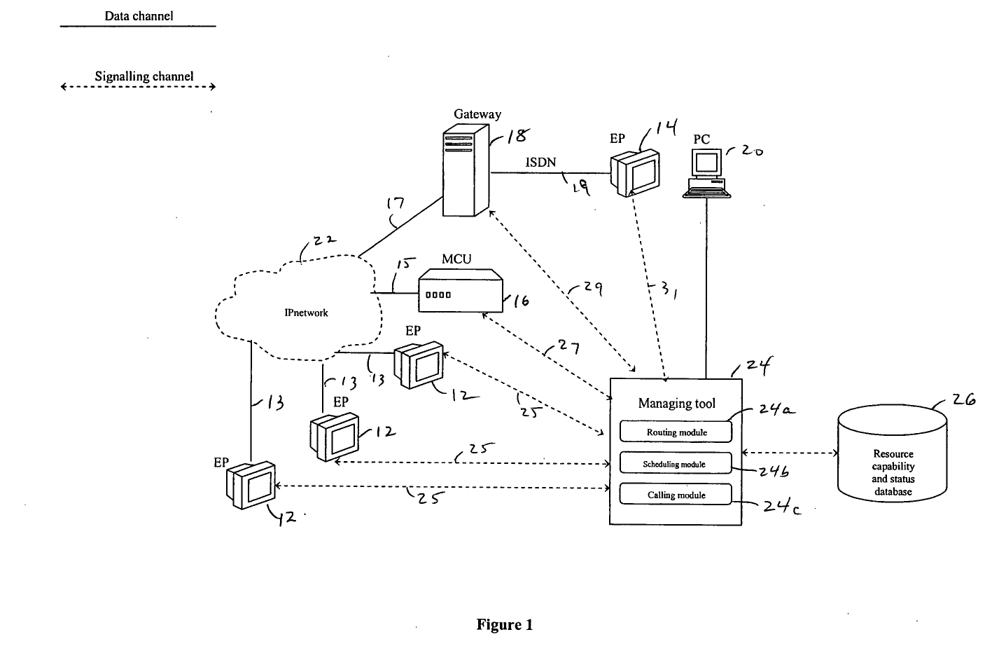

FIG. 1 is a block diagram illustrating elements of an example embodiment. The arrangement includes end-points 12, 14, multipoint control unit (MCU) 16 and gateway 18. The end-points 12 constitute SIP or H.323 end-points and are coupled to IP network 22 over data channels. The MCU 16 is also coupled to the IP network 22 over data channel 15. The gateway 18 interworks between H-320 end-point 14 and the IP network 22 over ISDN channel 19 and data channel 17.

Each of the elements is in communication with management tool 24 over respective signaling channels 25, 27, 29, 31. A PC 20 may connect to the management tool 24. The management tool includes a routing module 24a, scheduling module 24b, and calling module 24c. A database 26 in communication with the management tool provides information relating to resource capability and status.

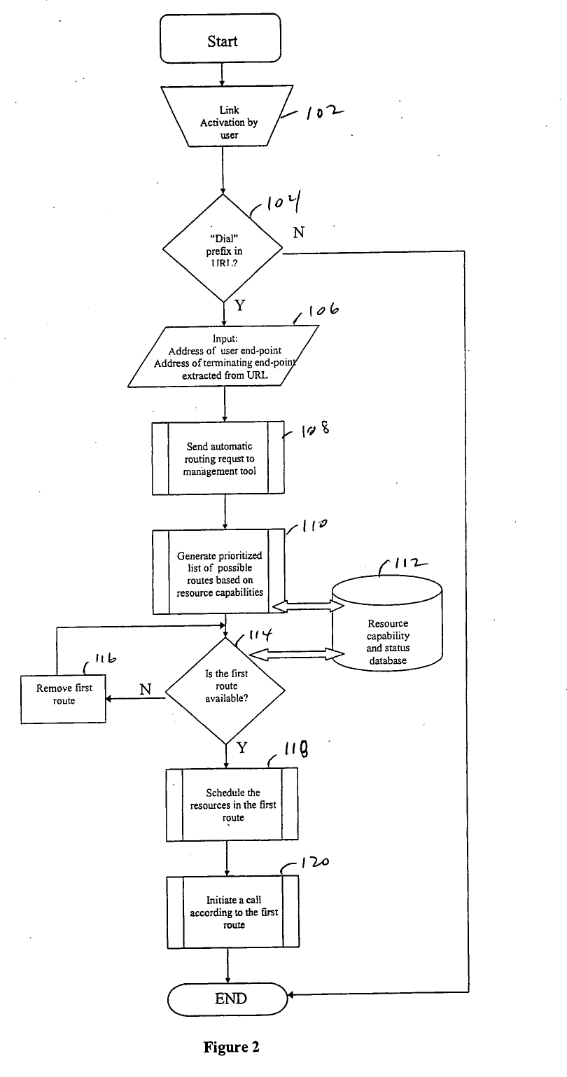

Referring now to FIG. 2, a flow sheet illustrates the steps of a method according to one aspect of the invention. The method starts processing based on link activation by the user at 102. If the content handler of the user web browser detects a dial prefix at 104, the addresses of the user end-point and/or the terminating end-point are extracted from the URL at 106. An automatic routing request is sent to the management tool 24 (FIG. 1) at 108. When the management tool receives the request from the content handler, the first step is to collect registered data about the end-points involved from a database 112 storing the capabilities of end-points and other resources like Gateways and MCUs. The capabilities of the end-points will then determine the required resources for establishing the call. As an example, if the originating end-point is a H.320 end-point, and the terminating end-point is a H.323 end-point, an intermediate Gateway will be required. Further, if the call is a conference call between multiple end-points, then an MCU will be required. A routing module 24a (FIG. 1) of the management tool will then generate a list of possible routes between the participating end-points based on capability and connection data captured from the database at 110. The routes include the intermediate nodes between the end-points and connection types (IP, ISDN) between them. The list is preferably arranged in a prioritized order, depending on a cost associated with each route. The cost may be deduced from a set of network parameters representing e.g. delay, bandwidth, reliability etc.

This list does not take into account whether the resources currently are available or not. The scheduling feature or module 24b (FIG. 1) of the management tool is capable of determining this. A scheduler module is always updated on the present and future status of its associated conferencing resources. This information is also stored in a database either separated from, or integrated in, the above-mentioned database storing capabilities. The uppermost route in the prioritized list having all the included resources available now and in a predefined period of time will then be selected at 114, 116, 118. The scheduling module will also book the resources for a default duration of e.g. 10 minutes to make sure that the call has access to the resources in a minimum of time. The scheduled time is preferably extended consecutively as the conference call proceeds.

The final step 120 for the management tool will be to actually initiate a call using the selected route. The set-up procedure is carried out by issuing commands to the originating end-point and the other selected resources in a similar way as for any other conference scheduled by a management tool.

Note that even if the example embodiment above describes a one-to-one connection, the invention is also applicable for ad-hoc multi-site conferencing initiated by one user. The dial-link may then include a group of originating end-points, or the user may click on multiple dial-links, all-participating in the same conference. The invention is neither limited to conventional videoconferencing. One or more of the participants could be web participants using a PC or other personal computer devices as the conference end-point. If the originating user is a web participant, the originating end-point is the web browser's terminal itself, and there is no need to predefine preferred end-points.

For a user, the present invention will appear easy and intuitive. As a dial-URL implicitly will include all required information for routing a call, one single click on a link in a web browser will be sufficient for establishing a call to a second party, or to a group of parties. Dial-links will be suitable to insert in e.g. contact information on an enterprise or a personal web site, or in e-mails.

While this invention has been particularly shown and described with references to preferred embodiments thereof, it will be understood by those skilled in the art that various changes in form and details may be made therein without departing from the scope of the invention encompassed by the appended claims.

1. A method for routing and establishing a call or a conference from an originating user to one or more terminating users each associated with one or more respective end-points, the method comprising:
when a URL (Universal Resource Locator) with a unique dial prefix is activated;
requesting a management tool to determine an available route of resources between a preferred one of the one or more end-points associated with the originating user and a respective preferred one of the one or more end-points respectively associated with the one or more terminating users;
determining, by means of a routing module included in said management tool, a number of routes between said preferred one of the one or more end-points associated with the originating user and said respective preferred one of the one or more end-points respectively associated with the one or more terminating users based on capability and connection data stored in a database for the respective end-points and said resources, and assigning a cost value to each of said number of routes representing delay, bandwidth and/or reliability;
determining, by means of a scheduling module included in said management tool, which of said number of routes whose resources currently and/or in near future are being idle, based on status data of said resources stored in said database, and selecting a route among which, having the lowest cost value, as said available route; and
establishing the call or conference from said preferred one of the one or more end-points associated with the originating user to said respective preferred one of the one or more end-points respectively associated with the one or more terminating users through said determined available route.

2. A method according to claim 1, characterized in that said unique prefix in said URL is followed by a respective identification of the terminating one or more users or the one or more end-points respectively associated with said one or more terminating users.

3. A method according to claim 1, characterized in that said unique prefix in said URL is followed by an identification of a group of the terminating one or more users or a group of the one or more end-points respectively associated with said one or more terminating users.

4. A method according to claim 1, characterized in that said scheduling module is adapted to book resources included in said available route for a predefined period of time and consecutively rebook the resources as the call or conference proceeds.

5. A method according to claim 1, characterized in that the step of establishing the call or conference further includes:
issuing set-up commands to said preferred one of the one or more end-points associated with the originating user for initiating said call or conference through said determined available route.

6. A system for routing and establishment of a call or a conference from an originating user to one or more terminating users each associated with one or more respective end-points, the system comprising:
a routing module adapted to determine a number of routes between a preferred one of the one or more end-points associated with the originating user and respective preferred one(s) of the one or more end-points respectively associated with the one or more terminating users, upon a URL (Universal Resource Locator) with a unique dial prefix being activated, based on capability and connection data stored in a database for the respective end-points and said resources, and further adapted to assign a cost value to each of said number of routes representing delay, bandwidth and/or reliability,
a scheduling module adapted to determine which of said number of routes whose resources currently and/or in near future are being idle, based on status data of said resources stored in said database, and to select a route among which having the lowest cost value, as a preferred route,
a calling module adapted to establishing the call or conference from said preferred one of the one or more end-points associated with the originating user to said respective preferred one of the one or more end-points respectively associated with the one or more terminating users through said preferred route.

7. A system according to claim 6, characterized in that said unique prefix in said URL is followed by a respective identification of the terminating one or more users or the one or more end-points respectively associated with said one or more terminating users.

8. A system according to claim 6, characterized in that said unique prefix in said URL is followed by an identification of a group of the terminating one or more users or a group of the one or more end-points respectively associated with said one or more terminating users.

9. A system according to claim 6, characterized in that said scheduling module further is adapted to book resources included in said available route for a predefined period of time and consecutively rebook as the call or conference proceeds.

10. A system according to claim 6, characterized in that said calling module further is adapted to issuing set-up commands to said preferred one of the one or more end-points associated with the originating user for initiating said call or conference through said determined available route.

11. A system according to claim 6, characterized in that said URL occurs in a web browser in said preferred one of the one or more end-points associated with the originating user or in a PC, mobile phone or PDA not participating in the call or conference.

12. A system according to claim 6, characterized in that said routing module, calling module and scheduling module is integrated in a managing tool.

13. A method for routing and establishing a call or a conference from an originating user to one or more terminating users each associated with one or more respective end-points, the method comprising:
upon activation of a URL (Universal Resource Locator) with a unique dial prefix,
receiving a request from the originating user to determine an available route of resources between a preferred one of the one or more end-points associated with the originating user and a respective preferred one of the one or more end-points respectively associated with the one or more terminating users;
determining a number of routes between said preferred one of the one or more end-points associated with the originating user and said respective preferred one of the one or more end-points respectively associated with the one or more terminating users based on capability and connection data stored in a database for the respective end-points and said resources, and assigning a cost value to each of said number of routes representing delay, bandwidth and/or reliability;
determining which of said number of routes whose resources currently and/or in near future are being idle, based on status data of said resources stored in said database, and selecting a route among which, having the lowest cost value, as said available route; and
establishing the call or conference from said preferred one of the one or more end-points associated with the originating user to said respective preferred one of the one or more end-points respectively associated with the one or more terminating users through said determined available route.

14. Apparatus for routing and establishing a call or a conference from an originating user to one or more terminating users each associated with one or more respective end-points, the apparatus comprising:
means for receiving a request from the originating user to determine an available route of resources between a preferred one of the one or more end-points associated with the originating user and a respective preferred one of the one or more end-points respectively associated with the one or more terminating users, upon a URL (Universal Resource Locator) with a unique dialing prefix being activated;
means for determining a number of routes between said preferred one of the one or more end-points associated with the originating user and said respective preferred one of the one or more end-points respectively associated with the one or more terminating users based on capability and connection data stored in a database for the respective end-points and said resources, and assigning a cost value to each of said number of routes representing delay, bandwidth and/or reliability;
means for determining which of said number of routes whose resources currently and/or in near future are being idle, based on status data of said resources stored in said database, and selecting a route among which, having the lowest cost value, as said available route; and
means for establishing the call or conference from said preferred one of the one or more end-points associated with the originating user to said respective preferred one of the one or more end-points respectively associated with the one or more terminating users through said determined available route.
